(19) United States
(12) Patent Application Publication
(10) Pub. No.: US 2014/0136238 A1
(43) Pub. Date: May 15, 2014

(54) VIDEO ARCHIVING FOR ON-LINE SERVICES

(71) Applicant: Jonathan Simon, Temple, PA (US)

(72) Inventor: Jonathan Simon, Temple, PA (US)

(21) Appl. No.: 14/079,978

(22) Filed: Nov. 14, 2013

Related U.S. Application Data
(60) Provisional application No. 61/726,715, filed on Nov. 15, 2012.

(51) Int. Cl. G06F 19/00

(52) U.S. Cl. CPC G06F 19/322
USPC 705/3

(57) ABSTRACT

An on-line physician care system having a system server and an archive storage device. A patient connects to the system with a patient computing device and is placed in a queue until a receptionist can be connected to the patient via a connection between the patient computing device and the receptionist computing device. An audio and video connection is provided to the receptionist for obtaining data is entered into the system server. The receptionist places the patient in a queue until a doctor is connected via a connection to a doctor computing device, providing an audio and visual connection. A diagnosis can be made, prescription issued, and the exchange captured in the archive storage device. An on-line system for archiving exchanges between a user and a service representative is also provided.

### INCORPORATION BY REFERENCE

The following documents are incorporated herein by reference as if fully set forth: U.S. Provisional Application No. 61/726,715, filed Nov. 15, 2013.

### FIELD OF INVENTION

Internet based, video conferencing, web applications have been developed that provide various services, such as a physician care service, to its users on-line. One such system has a network of board certified, primary care physicians who respond to patient requests within a few minutes, saving the patient 2 to 4 hours of time while providing the same visual and personal physician interaction experienced during a traditional office visit. The physician is able to diagnose common ailments or address a medical concern, and create medication prescriptions, which are forwarded to a pharmacy of the patient's choice through a virtual office visit.

### BACKGROUND

When a patient connects to one known on-line physician care system, such as the Rapid Remedy™ system owned by the assignee of the present application, the system places the patient on a wait queue, which is similar to a patient walking into a doctor's office and sitting in the waiting room. The patient is waiting for a receptionist to answer the call. The wait period is under 2 minutes typically. When the system receptionist answers the call, the receptionist asks the patient for several pieces of information. The receptionist asks for the patient's name, the last four digits of the patient's social security number, the patient's date of birth, and the reason for the call. The receptionist then determines a course of action based on their discussion with the patient. Some patients want to speak with a doctor; these are transferred to the next available physician. Other patients want to obtain prescription refills or a consultation letter. The receptionist handles these requests.

If the patient wants to speak with a licensed doctor and/or other health care provider, the receptionist transfers the patient to the doctor's wait queue, which is similar to a patient signing a log sheet at a doctor's office and returning to a seat in the waiting room. Another brief period of time ensues, while the patient waits for the doctor to answer the call.

Patients that speak with doctors may receive medication prescriptions, doctor's notes, and other advice. During the conference, the doctor ascertains the patient's condition and selects one or more diagnoses, which the patient sees in real-time. If medications are prescribed or a doctor's note is written, the patient sees these as well. The doctor sends prescriptions to the last pharmacy the patient used or to another pharmacy of the patient's choice. The system delivers prescriptions automatically to the pharmacy that the patient selects.

However, the issue of preserving the doctor-patient consultation has not been addressed for this type of system. When a patient sees a doctor in his office, the results of the meeting are usually just recorded in a patient's chart.

There are other types of services as well as data that would benefit from having a data archive for various interactions that are otherwise lost.

### SUMMARY

In one aspect of the invention, an on-line physician care system is provided having an on-line physician care system server and an archive storage device connected to the system server. The system server includes at least one processor and a memory with computer readable instructions. At least one patient computing device, at least one receptionist computing device, and at least one doctor computing device are provided, each of which is connected via the internet to the system server. Each of the computing devices is equipped with a camera, a speaker and a microphone, and can be mobile computing devices, such as smartphones or tablets, as well as PC's. The system server with the computer readable instructions is configured to:

access patient data for a patient logging into the system;

place the patient logging into the system in a queue until a receptionist can be connected to the patient via a connection between the patient computing device and the receptionist computing device;

connect the patient to the receptionist via the connection between the patient computing device and the receptionist computing device with an audio and video connection, the receptionist obtains additional data from the patient that is entered into the system server via at least one of the receptionist or the patient computing devices, and the receptionist placing the patient in a queue until a doctor can be connected to the patient via a connection between the patient computing device and the doctor computing device;

connect the patient to the doctor via a connection between the patient computing device and the doctor computing device with an audio and video connection; and

record a patient video and audio, and a doctor video and audio in order to capture an on-line diagnosis record of the video and audio of an entire exchange between the doctor and the patient, and the system server transfers the captured record to the archive storage device for storage along with identifiers to allow for retrieval.

In another aspect, the system server is programmed so that at least one of an entire exchange between the patient and the receptionist, any on-line patient or diagnosis information, or prescriptions are recorded by the system server and transferred to the archive storage device for storage along with the identifiers to allow for retrieval.

In a further embodiment, an archiving system for on-line system interactions, for example to a local storage archive, is provided. Here an on-line video, audio, and/or data exchange between a user and an on-line service is automatically recorded in an archive storage device along with identifiers, such as a user ID, date, and time, in order to allow for later retrieval.

### BRIEF DESCRIPTION OF THE DRAWINGS

The foregoing summary as well as the following detailed description will be best understood when read in conjunction with the appended drawings. In the drawings:

FIG. 1 is a schematic diagram of an on-line physician care system according to the invention that includes an archiving system for storing at least a doctor's diagnosis in a virtual patient file, as well as a video archive of the doctor-patient conference.

FIG. 2 is a screen print of a computer screen seen by the patient after accessing the system.

FIG. 3 is a screen print similar to FIG. 2 showing the receptionist responding to the initial patient query.

FIG. 4 is a screen print similar to FIG. 3 showing the initial information gathered by the receptionist being confirmed by the patient.

FIG. 5 is screen print similar to FIG. 4 showing the completion of a patent questionnaire by the patient.

FIG. 6 is a screen print similar to FIG. 5 showing the screen as seen by the patient during a wait period during the time the patient is transferred to a doctor's wait queue.

FIG. 7 is a screen print similar to FIG. 6 showing the doctor connected to the system.

FIG. 8 is a screen print similar to FIG. 7 showing the doctor's diagnosis, prescription, notes, as well as a preferred pharmacy where a prescription can be sent.

FIG. 9 is a screen print of a patient sign-off screen when the virtual office visit is completed.

FIG. 10 is a schematic diagram of an on-line archiving system for storing at least one of an audio, video, or data entry related to an on-line transaction or event.

### DETAILED DESCRIPTION OF THE PREFERRED EMBODIMENTS

The following detailed description is of the best presently contemplated mode of carrying out the present invention. However, this description is not to be taken as limiting, but as merely made for the purpose of illustrating the general principles of embodiments of the present invention. The scope of the present invention is best defined by the appended claims.

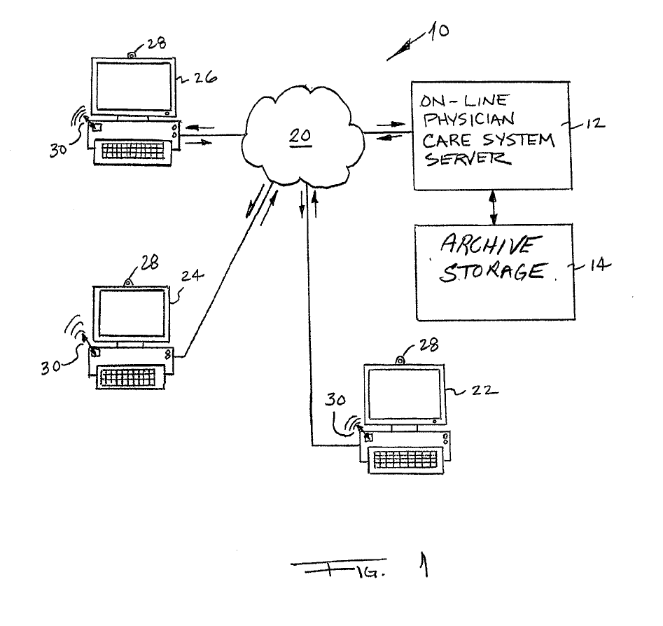

FIG. 1 depicts schematically an on-line physician care system 10 according to the present invention. As shown, the system 10 is preferably implemented via computing devices interconnected through the internet or a plurality of networks. The term “computing device” as used herein refers to any electronic computing device with a processor, such as a PC, tablet, smart phone, mobile telephone, or any other fixed or mobile device that allows internet or network access. The system 10 includes at least one on-line physician care system server 12 as well as preferably an archive storage device 14 connected to the server 12. Preferably the server or servers 12 includes a processor or a microprocessor of the conventionally known type which executes instructions. The archive storage device 14 can be magnetic media, such as a tape storage, one or more hard drives, optical media, or other types of storage such as a NAS (network attached storage) unit.

The server or servers 12 are connected via the internet 20 to at least one patient computing device 22, at least one receptionist computing device 24, and at least licensed service provider, e.g. doctor, computing device 26. Of course, those skilled in the art will recognize that multiple patient computing devices 22 are preferably connected or connectable to the system 10 and one or more receptionist and/or doctor computing devices 24, 26 are also connectable to the system 10. While an internet connection is preferred, other types of connections can be used. Each of these computing devices 22, 24, 26 is preferably equipped with a camera 28, as well as a microphone/speaker 30, typically provided as separate elements on or connected to each of the computers, but represented for the sake of simplicity as a single element 30. For example, the microphone could be wirelessly connected to a computer and be part of a headset and the speaker can be provided as an earpiece rather than using the microphone and speaker located on the computing device 22, 24, 26. As noted above, the computing devices can be a computer, such as a PC, or a mobile device such as a mobile telephone, PDA, tablet computing device, laptop, or other mobile computing device, all of which can be utilized in connection with the system 10. Additional input devices such as keyboards, mouse, pen, voice recognition and/or biometric mechanisms can be utilized in connection with the computing devices 22, 24, 26 to input data or receive data from the system 10.

The functionality of the system 10 is described in further detail below and is preferably carried out via software including instructions that are executed by the processor in the server or servers 12, with the software being contained in a tangible computer-readable medium, such as the memory. The computer readable medium is defined here as a fixed storage medium on which the software instructions are stored and may be a RAM, ROM or other static storage device or material.

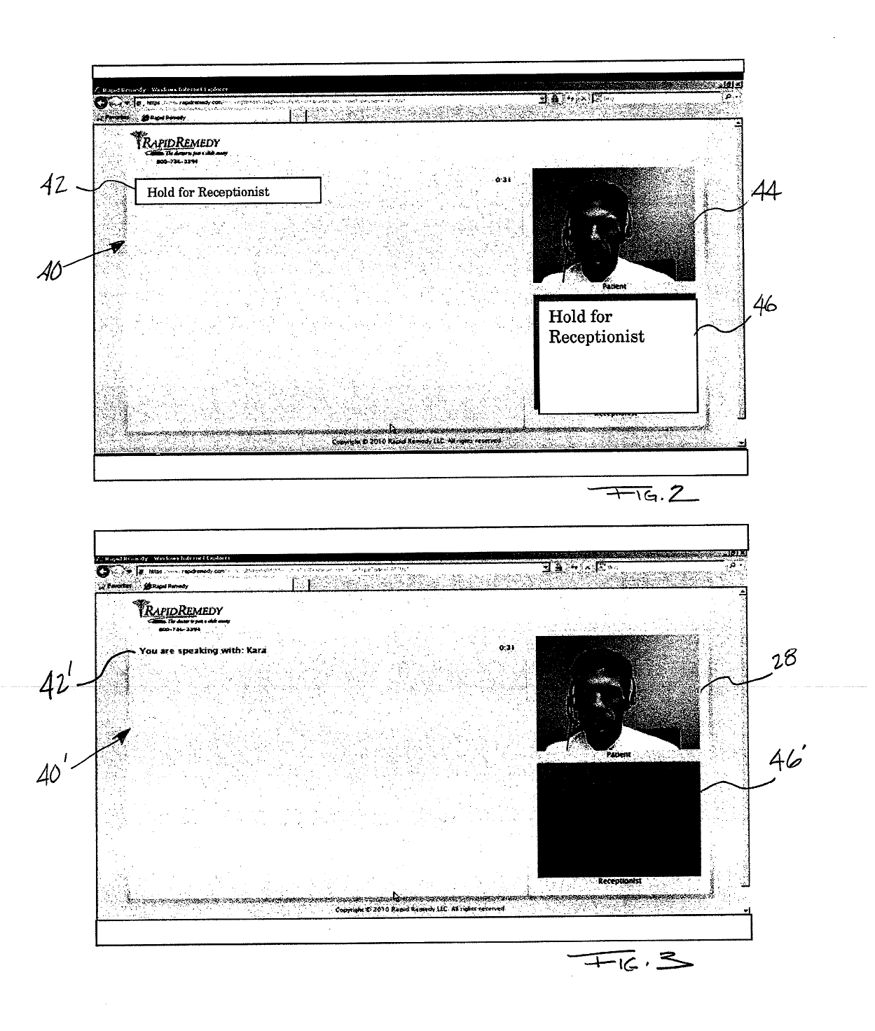

Referring now to FIG. 2, a patient can access the system 10 via the patient computing device 22 and is presented with a screen 40 as shown upon logging in, preferably with a user name and password. As shown, a status line 42 indicates the patient is on hold for a receptionist. Preferably, the screen on the patient's computing device 22 displays a view from the patient's camera 28 in a display area 44 and includes a display area 46 which can display the view from the receptionist computing device 24 or the doctor's computing device 26.

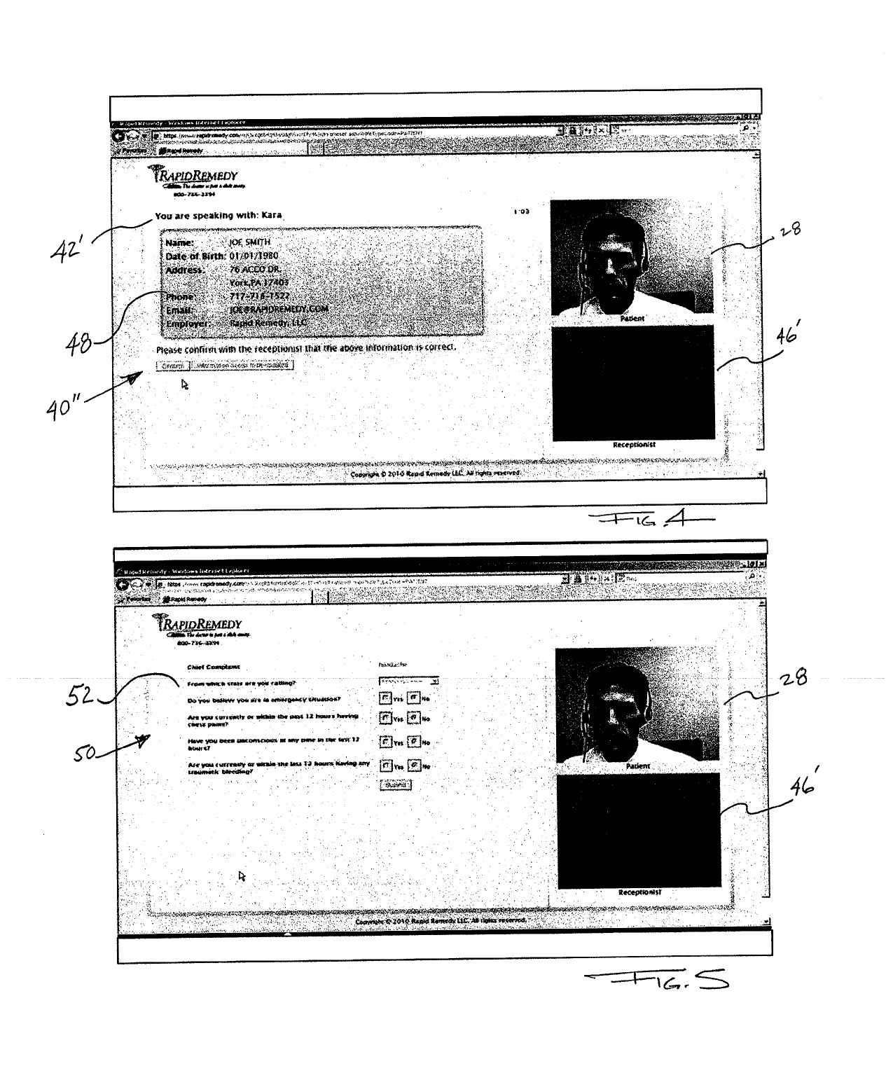

When the receptionist is connected, FIG. 3, the screen 40′ is updated with the current status line 42′ and the display area 46′ now shows the video of the receptionist. The patient information can be presented at field 48 in screen 40″, as shown in FIG. 4. The patient can then fill out a form with additional information regarding the reason for the call as shown in FIG. 5 on screen 50 in the patient questionnaire section 52. This can include data entered by the patient or the receptionist, such as the chief complaint, indicated as “headache” as well as additional information, including, for example, the state from which the patient is calling, whether the patient believes that it is an emergency situation, whether other conditions are indicated, such as having chest pains within the past 12 hours, having been unconscious within the past 12 hours, or having traumatic bleeding within the past 12 hours. This can be answered by the patient and/or with the assistance of the receptionist in order to determine whether emergency treatment is warranted.

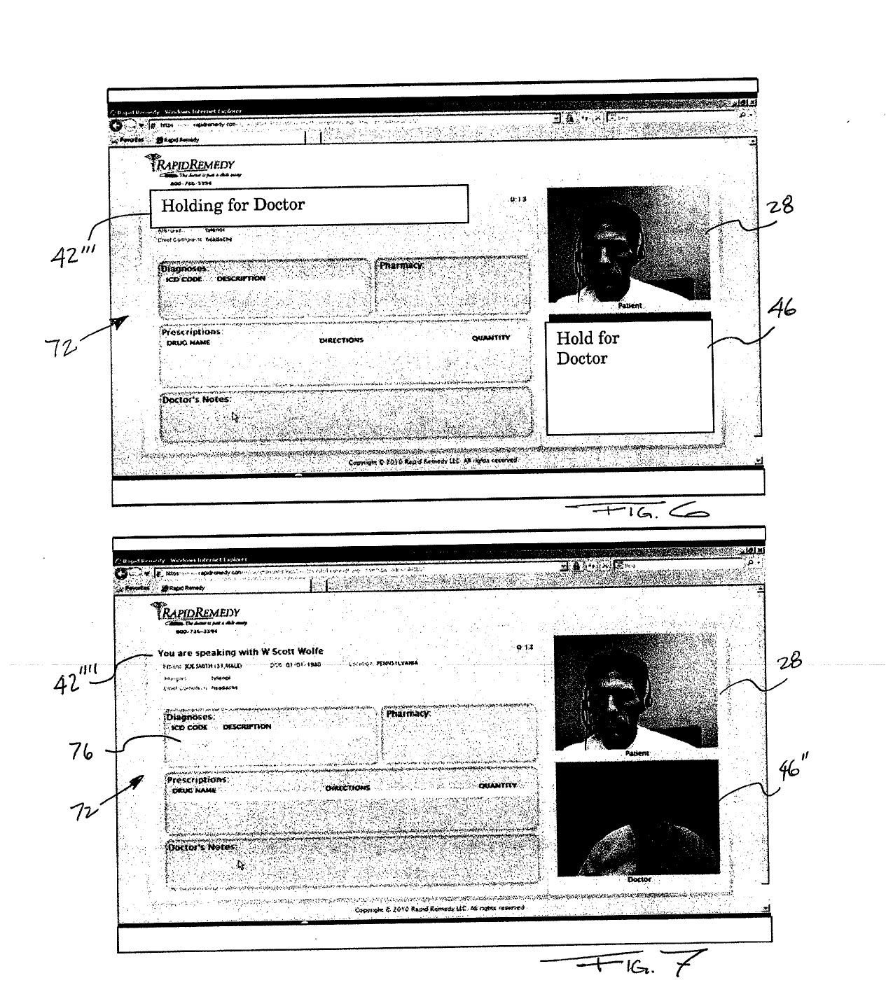

After this initial authentication and possibly triage by the receptionist, a diagnostic screen 72 is displayed as shown in FIG. 6. Here, the patient is placed in a waiting queue for the doctor and the status bar 42″ is updated to show that the patient is holding for the doctor.

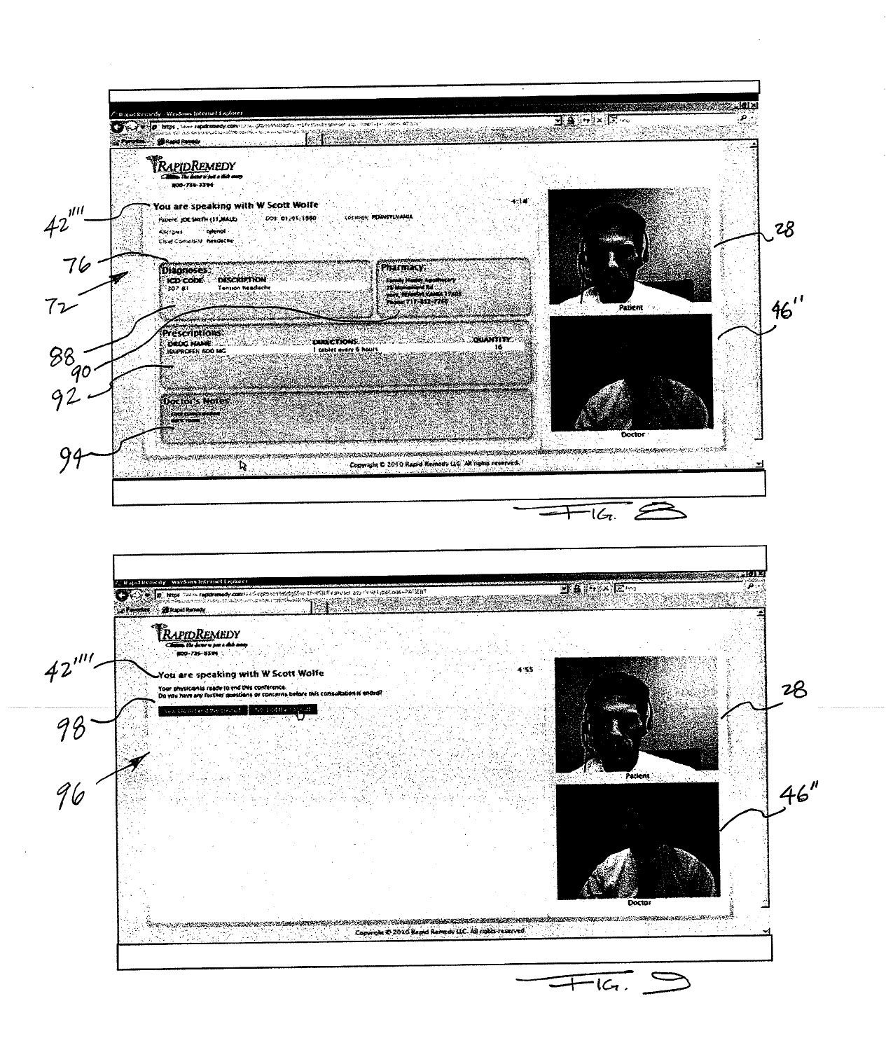

Referring to FIG. 7, the doctor is connected through the doctor's computing device 26 to provide a virtual office visit with the patient, and the doctor is displayed in the updated service camera view 46″. Preferably the status bar 42″ is updated to indicate the patient is connected with the doctor. As shown in FIG. 8, the diagnostic screen 72 includes diagnostic entry fields 76 that can be updated with a patient diagnosis at 88, a preferred pharmacy at 90, a prescription that is delivered to the pharmacy at 92, as well as any additional doctor notes regarding the symptoms and/or additional treatments available at 94. The doctor and patient can see one another via the cameras 28 on the respective computing devices 22, 26 and the display area provided at 44 and 46″. This allows an interactive virtual patient visit to the doctor which the doctor can respond directly to any specific questions of the patient.

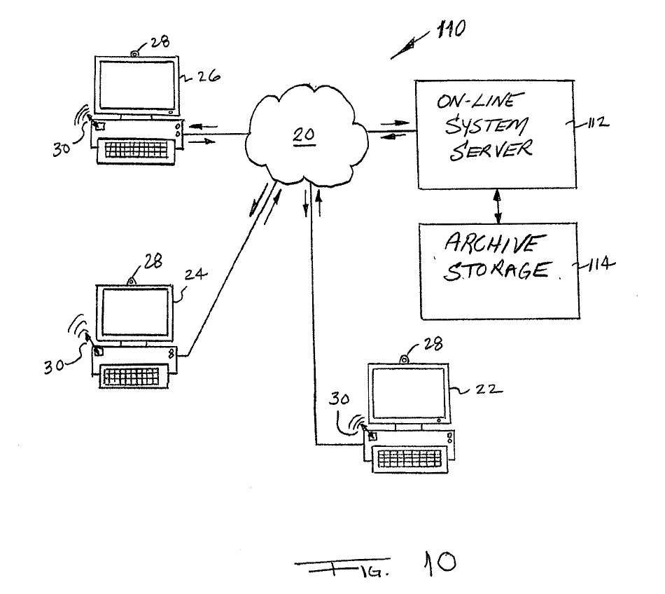

When the virtual office visit is complete as shown in FIG. 9 at screen 96, the patient can sign off ending the virtual office visit via clicking on the query provided at 98.

During the entire office visit, the processor for the system server 12 executes program instructions to record at least one of the on-line diagnosis record (at least field 76), the patient video and audio (as displayed at 28) and the doctor video and audio (as displayed at 46″), as well as possibly the receptionist video and audio (as displayed at 46′) in order to capture a record of at least the on-line diagnosis, and more preferably the on-line diagnosis as well as the audio and video conference between the doctor and the patient, and most preferably, the entire exchange of information between the patient and the doctor, as well as any on-line patient or diagnosis information (screen 72 and all information entered), as well as any prescriptions (field 92), and the system server 12 then transfers this information to the archive storage device 14 for storage along with certain identifiers to allow for retrieval, if necessary.

These recorded encounters in the system 10 according to the invention allow for the capture of as much or more data than is currently captured during a traditional physician care visit in a doctor's office, which is not recorded. Patients may feel uncomfortable speaking to their physician in front of a video camera. Therefore, health care professionals resort to others means in order to prevent disputes. These means may include the presence of another associate inside the examining room during a portion of the visit.

The system 10 according to the invention obviates this issue because the patient is using his or her own camera at home or in a secure location. And the fact that these encounters are recorded with the patient's approval provides physicians using the system 10 with a level of protection. Regardless of the source, web browser or hand-held device, the system 10 preferably records at least all encounters between patients and physicians in an efficient, electronic format. These recordings are then stored in the storage device 14, which is preferably in a secure facility.

Preferably, the system 10 creates a unique identifier for user video streams at the time each encounter starts. This can be a combination of a patient or subscriber code and a date/time stamp, or other assigned identifier. These unique identifiers are recorded in a database and associated with the patient and/or service subscriber. The patient preferably is also assigned a stream identifier and the physician is assigned a stream identifier. The system matches these stream identifiers with an encounter identifier. In this way, the system 10 ensures that the correct video streams are delivered to each user during the encounter and after the encounter, when the stream is archived in the storage device 14 for possible later retrieval.

Additional details of the encounter are recorded in a database on the storage device 14 and associated with an encounter identifier so that they can be retrieved and associated with the audio and video recording. These additional details include at least diagnoses, prescriptions, pharmacy information, and doctor notes.

Referring now to FIG. 10, an on-line system 110 according to the present invention is shown. As shown, the system 110 is preferably implemented via computing devices interconnected through the internet or a plurality of networks. The system 110 includes at least one on-line system server 112 as well as preferably an archive storage device 114 connected to the server 112. Preferably the server or servers 112 includes one or more processors or microprocessors of the conventionally known type which execute instructions. The archive storage device 114 can be magnetic media, such as a tape storage, one or more hard drives, optical media, or other types of storage such as a NAS (network attached storage) unit.

The server or servers 112 are connected via the internet 20 to at least one user computing device 22 and to at least one service provider computing device 24, 26. Of course, those skilled in the art will recognize that multiple user computing devices 22 are preferably connected or connectable to the system 110 and one or more service provider computing devices 24, 26 are also connectable to the system 10. While an internet connection is preferred, other types of connections can be used. Each of these computing devices 22, 24, 26 is preferably equipped with a camera 28, as well as a microphone/speaker 30, typically provided as separate elements on or connected to each of the computers, but represented for the sake of simplicity as a single element 30. For example, the microphone could be wirelessly connected to a computer and be part of a headset and the speaker can be provided as an earpiece rather than using the microphone and speaker located on the computing device 22, 24, 26. As noted above, the computing devices can be a computer, such as a PC, or a mobile device such as a mobile telephone, PDA, tablet computing device, laptop, or other mobile computing device, all of which can be utilized in connection with the system 110. Additional input devices such as keyboards, mouse, pen, voice recognition and/or biometric mechanisms can be utilized in connection with the computing devices 22, 24, 26 to input data or receive data from the system 110.

The functionality of the system 110 is described in further detail below and is preferably carried out via software including instructions that are executed by the processor in the server or servers 112, with the software being contained in a tangible computer-readable medium, such as the memory. The computer readable medium is defined here as a fixed storage medium on which the software instructions are stored and may be a RAM, ROM or other static storage device or material.

In use, the system 110 can be, for example, a medical data input system, such as for home monitoring of blood sugar, pulse, and/or blood pressure. It can also be an on-line therapist system, an on-line banking system, an on-line retailer, etc. During a user initiated exchange with the system 110, the processor for the system server 112 executes program instructions to record at least one of an on-line audio, video, and/or data input into the system, and also records any response from the service system back to the user. Accordingly, an archive record of any user-service exchange over the system 110 is recorded. Preferably, all audio and/or video exchanges between the service and the user are recorded, and most preferably, the entire exchange of information between the user and the service, as well as any on-line screen data that is entered. The system server 112 then transfers this information to the archive storage device 114 for storage along with certain identifiers to allow for retrieval, if necessary. The identifiers can be for example, a user or customer ID, as well as a date and time stamp.

It will be appreciated by those skilled in the art that the embodiments and methods described above are considered to be merely exemplary and that the specific examples provided are not considered limiting. Further, the invention includes various combinations and sub-combinations of the system configuration and methods of implementation discussed above.

What is claimed is:

1. An on-line physician care system, comprising:
an on-line physician care system server and an archive storage device connected to the system server, the system server including at least one processor and a memory with computer readable instructions;
at least one patient computing device, at least one receptionist computing device, and at least one doctor computing device, each of which is connected to the system server, each of the computing devices being equipped with a camera, a speaker and a microphone;
the system server with the computer readable instructions being configured to:
access patient data for a patient logging into the system;
place the patient logging into the system in a queue until a receptionist can be connected to the patient via a connection between the patient computing device and the receptionist computing device;
connect the patient to the receptionist via the connection between the patient computing device and the receptionist computing device with an audio and video connection, the receptionist obtaining additional data from the patient that is entered into the system server via at least one of the receptionist or the patient computing devices, and the receptionist placing the patient in a queue until a doctor can be connected to the patient via a connection between the patient computing device and the doctor computing device;
connect the patient to the doctor via a connection between the patient computing device and the doctor computing device with an audio and video connection; and
record at least an on-line diagnosis record, a patient video and audio, and a doctor video and audio in order to capture a record of at least an on-line diagnosis between the doctor and the patient, and the system server transfers the captured record to the archive storage device for storage along with identifiers to allow for retrieval.

2. The system of claim 1, wherein the system server is programmed so that an entire exchange between the patient and the doctor via the respective computing devices is recorded by the system server.

3. The system of claim 1, wherein the system server is programmed so that any on-line patient or diagnosis information, or prescriptions are recorded by the system server and transferred to the archive storage device for storage along with the identifiers to allow for retrieval.

4. The system of claim 1, wherein the system server is programmed so that an entire exchange between the patient and the receptionist is recorded by the system server and transferred to the archive storage device for storage along with the identifiers to allow for retrieval.

5. The system of claim 1, wherein the system server is programmed so that an entire exchange of the audio and video connection from and to the patient is recorded by the system server and transferred to the archive storage device for storage along with the identifiers to allow for retrieval.

6. The system of claim 1, wherein the system server is programmed so that the additional data from the patient that is entered into the system server via at least one of the receptionist or the patient computing devices and any information entered into the system server by the doctor during the virtual office visit is recorded by the system server and transferred to the archive storage device for storage along with the identifiers to allow for retrieval.

7. The system of claim 1, wherein the identifiers include at least one of a patient code and a date/time stamp.

8. The system of claim 1, wherein the storage device comprises at least one of a magnetic media, a hard drive, an optical media, or a NAS (network attached storage) unit.

9. The system of claim 1, wherein the computing devices comprise at least one of a computer, a mobile device, a mobile telephone, PDA, tablet computing device, or laptop.

10. An on-line system, comprising:
an on-line system server and an archive storage device connected to the system server, the system server including at least one processor and a memory with computer readable instructions;
at least one user computing device, and at least one service computing device, each of which is connected to the system server, each of the computing devices being equipped with a camera, a speaker and a microphone;
the system server with the computer readable instructions being configured to:
access user data for a user logging into the system;
connect the user to a service representative via the connection between the user computing device and the service computing device with an audio and video connection, the service representative obtaining additional data from the user that is entered into the system server via at least one of the service representative or the user computing devices; and
record at least an on-line service record, a user video and audio, and a service provider video and audio in order to capture a record of at least one of a video and audio of an entire exchange between the service provider and the user, and the system server transfers the captured record to the archive storage device for storage along with identifiers to allow for retrieval.

11. The system of claim 10, wherein the system server is programmed so that the additional data from the user that is entered into the system server via at least one of the user or the service representative computing device is recorded by the system server and transferred to the archive storage device for storage along with the identifiers to allow for retrieval.

12. The system of claim 10, wherein the identifiers include at least one of a user code and a date/time stamp.
